(19) United States
(12) Patent Application Publication
(10) Pub. No.: US 2018/0224985 A1
(43) Pub. Date: Aug. 9, 2018

(54) TOUCH PANEL AND TOUCH DISPLAY DEVICE APPLYING THE SAME

(71) Applicant: Innolux Corporation, Miao-Li County (TW)

(72) Inventors: Sheng-Huang WU, Miao-Li County (TW); Wei-Cheng LEE, Miao-Li County (TW); Tzu-Pin HSIAO, Miao-Li County (TW); Yen-Hui LI, Miao-Li County (TW); Chien-Chih LIAO, Miao-Li County (TW); Hsien-Wen HUANG, Miao-Li County (TW); Jiunn-Shyong LIN, Miao-Li County (TW)

(21) Appl. No.: 15/877,451

(22) Filed: Jan. 23, 2018

(30) Foreign Application Priority Data
Feb. 3, 2017 (CN) 201710063726.3

(51) Int. Cl. G06F 3/041; H01B 1/22; B32B 15/04

(52) U.S. Cl. CPC G06F 3/0412; H01B 1/22; B32B 15/04; B32B 2309/105; G06F 2203/04103; G06F 2203/04112; B32B 2457/208; B32B 2307/412

(57) ABSTRACT

A touch panel includes a substrate, a conductive layer and a cover layer. The conductive layer is disposed on the substrate. The cover layer is disposed on the conductive layer, and includes a nonmetal element dispersed therein, wherein the cover layer has a thickness of T. The nonmetal element at a location of the cover layer where spaced from the conductive layer for a distance of 1/12T has a first concentration, and the nonmetal element at a location of the cover layer where spaced from the conductive layer for a distance of 7/12T has a second concentration, wherein the first concentration is less than the second concentration.

This application claims the benefit of People's Republic of China application Serial No. 201710063726.3, filed Feb. 3, 2017, the subject matter of which is incorporated herein by reference.

### TECHNICAL FIELD

The disclosure relates in general to a touch panel and applications thereof; and more particularly to a touch panel having a multi-layer structure and applications thereof.

### BACKGROUND

A conductive thin film that has optical characteristics of transparency can be applied to serve as a sensor layer of a touch panel. A conventional sensor layer of a touch panel is typically formed by depositing a conductive material layer on a substrate with a deposition process, such as a chemical vapor deposition (CVD) or a physical vapor deposition (PVD); and the conductive material layer is then patterned to form a plurality of sensing electrodes. In order to satisfy the low resistance requirement of the sensing electrodes, currently a sensing electrode with a metal mesh structure has been applied in the touch panel.

### SUMMARY

According to one embodiment of the present disclosure, a touch panel is disclosed, wherein the touch panel includes a substrate, a conductive layer and a cover layer. The conductive layer is disposed on the substrate. The cover layer is disposed on the conductive layer, and includes a nonmetal element dispersed therein, wherein the cover layer has a thickness of T. The nonmetal element at a first location of the cover layer where spaced from the conductive layer for a distance of 1/12T has a first concentration, and the nonmetal element at a second location of the cover layer where spaced from the conductive layer for a distance of 7/12T has a second concentration, wherein the first concentration is less than the second concentration.

According to another embodiment of the present disclosure, a touch display device is disclosed, wherein the touch display device includes a touch panel and a display unit. The touch display device disposed on one side of the display unit, wherein the touch panel includes a substrate, a conductive layer and a cover layer. The conductive layer is disposed on the substrate. The cover layer is disposed on the conductive layer, and includes a nonmetal element dispersed therein, wherein the cover layer has a thickness of T. The nonmetal element at a first location of the cover layer where spaced from the conductive layer for a distance of 1/12T has a first concentration; and the nonmetal element at a second location of the cover layer where spaced from the conductive layer for a distance of 7/12T has a second concentration; wherein the first concentration is less than the second concentration.

### BRIEF DESCRIPTION OF THE DRAWINGS

The disclosure can be more fully understood by reading the subsequent detailed description and examples with references made to the accompanying drawings, wherein:

FIGS. 1A to 1D are cross-sectional views illustrating the processing structure for fabricating a touch panel according to one embodiment of the present disclosure;

FIG. 2 is a cross-sectional view of a touch panel according to another embodiment of the present disclosure;

FIG. 3 is a cross-sectional view of a touch panel according to yet another embodiment of the present disclosure;

FIG. 4 is a cross-sectional view of a touch panel according to yet another embodiment of the present disclosure;

FIG. 5 is a cross-sectional view of a touch panel according to yet another embodiment of the present disclosure;

FIG. 6A is a curve diagram illustrating the variation in sheet resistance of the touch panel provided by the embodiment of the present disclosure between different manufacturing batches;

FIG. 6B is a curve diagram illustrating the variation in sheet resistance of touch panels fabricated by a conventional continuous metal nitriding coating process in different batches;

FIG. 7 is a cross-sectional view illustrating a touch display device applying the touch panel depicted in FIG. 3; and

FIGS. 8A to 8C illustrate various concentration gradients of a nonmetal element disposed in the cover layer according to different embodiments of the present disclosure.

### DETAILED DESCRIPTION

According to the present disclosure, a touch panel and a touch display device applying the same. A number of embodiments of the present disclosure are disclosed below with reference to accompanying drawings.

However, the structure and content disclosed in the embodiments are for exemplary and explanatory purposes only, and the scope of protection of the present disclosure is not limited to the embodiments. Designations common to the accompanying drawings and embodiments are used to indicate identical or similar elements. It should be noted that the present disclosure does not illustrate all possible embodiments, and anyone skilled in the technology field of the invention will be able to make suitable modifications or changes based on the specification disclosed below to meet actual needs without breaching the spirit of the invention. The present disclosure is applicable to other implementations not disclosed in the specification. In addition, the drawings are simplified such that the content of the embodiments can be dearly described, and the shapes, sizes and scales of elements are schematically shown in the drawings for explanatory and exemplary purposes only, not for limiting the scope of protection of the present disclosure.

It should be appreciated that when a description expresses that a first feature is disposed on second feature, it includes the situation that the first feature is directly contacting to the second feature and the situation that there is another feature inserted between the first feature and the second feature, so as to make the first feature not directly in contacting to the second feature.

In some embodiments of the present disclosure, the cover layer includes a nonmetal element, such as metal nitride or metal oxide dispersed therein which can absorb incident light come from the circumstance. The color of the cover layer is not limited and can vary depending upon the composition of the metal nitride or metal oxide dispersed therein.

In the present embodiment, the concentration of the nonmetal element dispersed in the cover layer can be measured by (but not limited to) an energy dispersive X-ray spectrometer (EDX), which can determine the concentration distributions of the nonmetal element along depth direction (the direction parallel to the Z axis) of the cover layer. The concentration of the nonmetal element can be the atomic percentage (at %) or the weight percentage (wt %) of the nonmetal element. In addition, since different portions of the cover layer processing different concentrations of the nonmetal element may have different etching rate against a predetermined etchant, thus the fact that there exists a concentration gradient distribution of the nonmetal element in the cover layer can be confirmed by an etching test using the predetermined etchant.

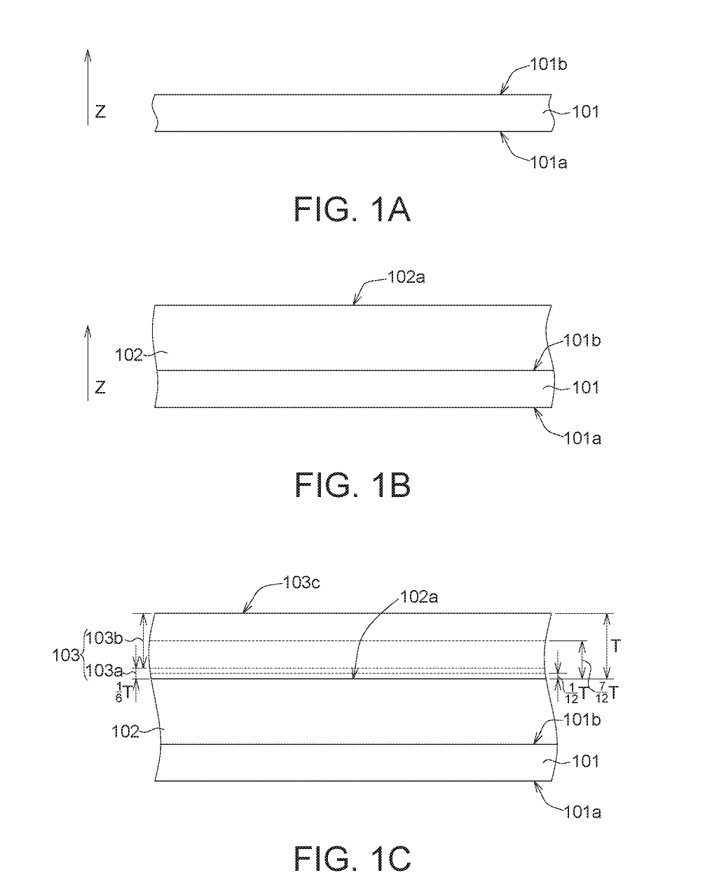

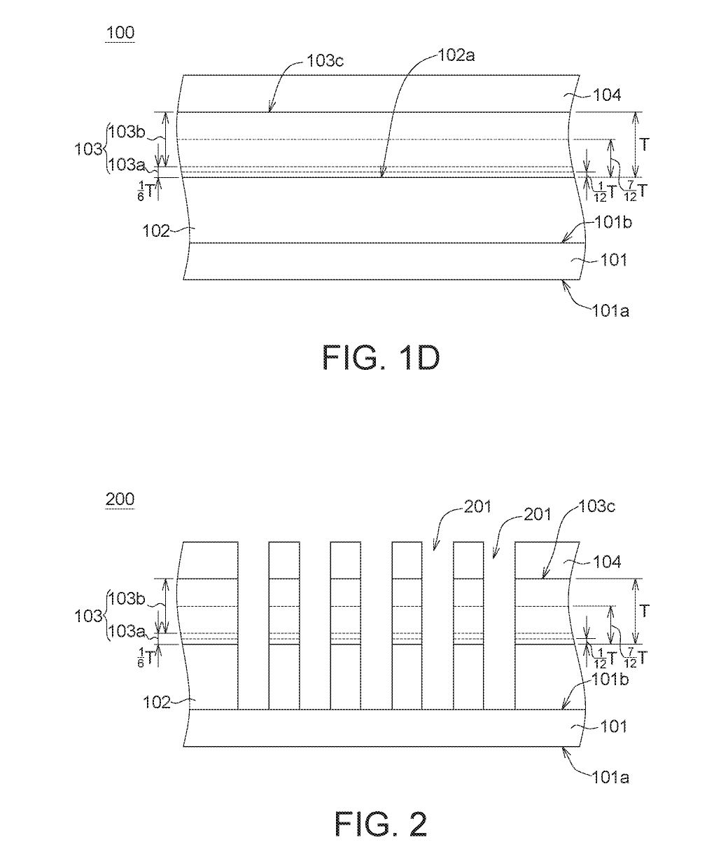

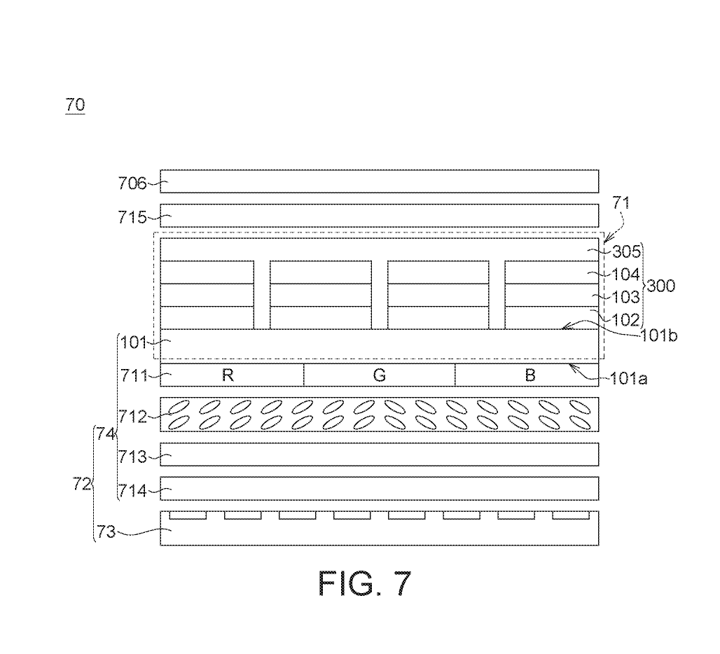

FIGS. 1A to 1D are cross-sectional views illustrating the processing structure for fabricating a touch panel 100 according to one embodiment of the present disclosure, wherein the method for fabricating the touch panel 100 includes following steps. However, it should be noted that the sequence of the steps can be varied depending on the process design. Firstly, a substrate 101 is provided (see FIG. 1A). Please also refer to FIG. 7, in one embodiment of the present disclosure, the substrate 101 can be a transparent substrate of a display panel 74. A color filter 711 disposed on the substrate 101. For example, the color filter 711 of the display panel 74 is disposed on a bottom surface 101a of the transparent substrate (the substrate 101) facing the display medium layer 712, and the touch panel 300 is disposed on the top surface 101b of the substrate 101 opposite to the bottom surface 101a. In some other embodiments, the substrate 101 may be an encapsulation layer, an inorganic-organic-inorganic layer, a barrier layer, a polarizer or other suitable transparent substrate disposed on the light emitting layer of the display panel 74.

Next, a conductive layer 102 is disposed on the top surface 101b of the substrate 101 along a direction parallel to the Z axis. In an embodiment of the present disclosure, the conductive layer 102 may be a metal film formed by a deposition process, such as a sputtering process, a CVD process, a PVD process or any other suitable method, on the top surface 101b of the substrate 101. The metal film may include a metal material selected from a group consisting of gold (Au), silver (Ag), titanium (Ti), tungsten (W), indium (In), zinc (Zn), aluminum (Al), neodymium (Nd), copper (Cu) and the arbitrary combinations thereof. The conductive layer 102 has a thickness substantially ranging from 3000 angstrom (A) to 6000 Å, or more particularly from 4000 Å to 5000 Å. However, the thickness of the conductive layer 102 may not be limited to these regards, the thickness of the conductive layer 102 can be varied depending upon the resistance of the metal material for composing the same. For example, the conductive layer 102 can be thinner, when the metal material for composing the same has less resistance. In one embodiment of the present disclosure, the conductive layer 102 can be an aluminum alloy layer with a thickness of 4500 Å.

A cover layer 103 is then disposed on the top surface 102a of the conductive layer 102 along the direction parallel to the Z axis. The cover layer 103 includes a kind of the nonmetal element dispersed therein, and the nonmetal element has different concentrations in different locations of the cover layer 103, wherein the concentration of the nonmetal element at a location spaced more from the conductive layer 102 may be greater than that of the nonmetal element at the location getting closer the conductive layer 102. In one embodiment of the present disclosure, the cover layer 103 can be a metal nitride layer. The cover layer 103 has a thickness T; the nonmetal element at a location of the cover layer 103 where spaced from the conductive layer 102 for a distance of 1/12T has a first concentration; and the nonmetal element at a location of the cover layer 103 where spaced from the conductive layer 102 for a distance of 7/12T has a second concentration, wherein the first concentration is less than the second concentration.

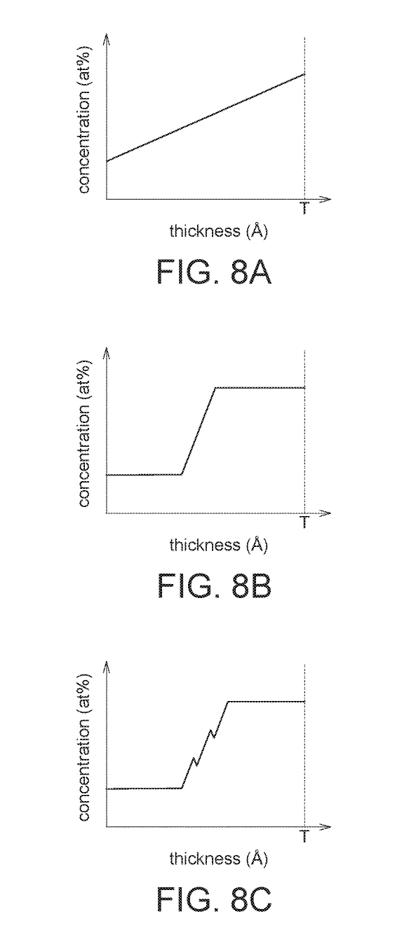

In one embodiment of the present disclosure, the nonmetal element disposed in the cover layer 103 have a concentration gradient, wherein the cover layer 103 can be a metal nitride layer; and the nonmetal element can be a nitrogen element (N). The concentration, such as at % or wt %, of the nitrogen element (N) dispersed in the cover layer 103 may be increased along the direction away from the conductive layer 102. In the embodiment where the cover layer 103 have a concentration gradient, the nonmetal element dispersed in the cover layer 103 has a concentration gradually increased along the direction away from the conductive layer 102. FIGS. 8A to 8C illustrate various concentration gradients of the nonmetal element disposed in the cover layer according to different embodiments of the present disclosure. In the embodiment of FIG. 8A, the concentration of the nonmetal element dispersed in the cover layer 103 is continuously increased along the direction away from the conductive layer 102. In the embodiment of FIG. 8B, the concentration of the nonmetal element dispersed in the cover layer 103 is steeply increased along the direction away from the conductive layer 102 from a low concentration profile to a high concentration profile. In the embodiment of FIG. 8C, the concentration of the nonmetal element dispersed in the cover layer 103 may be slightly decayed for several times during the increase of the concentration. In some other embodiment of the present disclosure, the cover layer 103 can be a metal oxide layer; and the nonmetal element can be an oxygen element (O). Although the curves, as depicted in FIGS. 8A to 8C, are linear, but the curve profile cannot be limited to these regards. In some other embodiments of the present disclosure, the curves illustrating the relationship of the thickness of the cover layer 103 and the concentration of the of the nonmetal element dispersed therein may be linear or nonlinear.

In one embodiment of the present disclosure, the cover layer can be an aluminum-containing alloy nitride (Al—X—N) layer. The cover layer 103 has a thickness T; the nonmetal element (in the present embodiment may be the nitrogen element (N)) at a location of the cover layer 103 where spaced from the conductive layer 102 for a distance of 1/12T has a first concentration; and the nonmetal element (nitrogen element (N)) at a location of the cover layer 103 where spaced from the conductive layer 102 for a distance of 7/12T has a second concentration, wherein the first concentration is less than the second concentration. For example, the first concentration can be greater than or equal to 2 at % and less than or equal to 30 at %; and the second concentration can be greater than or equal to 30 at % and less than or equal to 80 at %. In one embodiment of the present disclosure, the first concentration can be about 20 at % and the second concentration can be about 40 at %. Of note that the first concentration and the second concentration may not be limited to these regards. The concentration of the nonmetal element can be measured by energy-dispersive X-ray spectroscopy (EDX) or secondary ion mass spectrometry (SIMS). For example, in one embodiment of the present disclosure, the concentration of the nonmetal element can be determined by analyzing the energy spectrum of the electronic bean passing at the predetermined test areas (the locations of the cover layer 103 where spaced from the conductive layer 102 for a distance of 1/12T and 7/12T respectively). In some other embodiments, the concentration of the nonmetal element can be determined by transmission electron microscopy(TEM)-EDX or scanning electron microscopy(SEM)-EDX using a scanning line to scan the predetermined test areas. However, it should be appreciated that the method for determine the concentration of the nonmetal element may not be limited to these regards, and in some embodiments, the nonmetal element may be the oxygen element (O).

In one embodiment of the present disclosure, the nonmetal element (in the present embodiment may be the nitrogen element (N)) dispersed in the region of the cover layer 103 from the top surface 102a of the conductive layer 102 to the locations spaced from the top surface 102a for a distance of ⅙T has a first average concentration; and the nonmetal element (in the present embodiment may be the nitrogen element (N)) dispersed in the region of the cover layer 103 from the ⅙T locations to the locations (that composing the top surface 103c of the cover layer 103) spaced from the top surface 102a for a distance of T has a second average concentration; wherein the first average concentration is less than the second average concentration. In one embodiment of the present disclosure, the first average concentration can be about 20 at %; and the second average concentration can be about 40 at %. In one embodiment of the present disclosure, the concentrations of the nonmetal element at different locations distributed all over the cover layer 103 can be firstly determined by using TEM-EDX or SEM-EDX technology, and the first average concentration and the second average concentration can be thus obtained by calculation (using a mathematic module such as integral, or any other calculating module built in the apparatus for analyzing the TEM-EDX or SEM-EDX). However, it should be appreciated that the first average concentration and the second average concentration as well as the method for determine the same may not be limited to these regards, and in some embodiments, the nonmetal element may be the oxygen element (O).

In one embodiment of the present disclosure, the cover layer 103 may be formed by a sputtering process within a nitrogen-containing atmosphere, in which a high energy plasma is formed by argon or other inert gas to bombard an aluminum alloy target, whereby an Al—X—N layer is then formed on the top surface 102a of the conductive layer 102. The aluminum alloy target can be made of aluminum and at least one metal elements other than aluminum, such as Nd, Cu, Au, Ag, Ti, W, In, Zn and the arbitrary combinations thereof. The thickness T of the cover layer 103 may range from (but not be limited to) 300 Å to 1000 Å (300 Å≤T≤1000 Å). During the process for forming the cover layer 103, the concentration of the nitrogen element (N) dispersed in the cover layer 103 can be manipulated by tuning the nitrogen concentration within nitrogen-containing atmosphere, so as to form at least one low nitrogen-containing portion 103a and at least one high nitrogen-containing portion 103b in the cover layer 103. For example, during the process for forming the cover layer 103, the low nitrogen-containing portion 103a can be firstly formed in the nitrogen-containing atmosphere with less nitrogen gas, and the high nitrogen-containing portion 103b is then formed by increasing the concentration of nitrogen gas in the nitrogen-containing atmosphere. The thicknesses of the low nitrogen-containing portion 103a and high nitrogen-containing portion 103b can be manipulated by controlling the deposition time implemented within different nitrogen-containing atmospheres. For example, the low nitrogen-containing portion 103a can be formed in the nitrogen-containing atmosphere with less nitrogen gas for a first-time interval; and then the high nitrogen-containing portion 103b can be formed in the nitrogen-containing atmosphere with more nitrogen gas for a second-time interval. If the first-time interval is less than the second-time interval, the low nitrogen-containing portion 103a can be thus thinner than the high nitrogen-containing portion 103b. In one embodiment of the present disclosure, the low nitrogen-containing portion 103a can be the region of the cover layer 103 from the top surface 102a of the conductive layer 102 to the locations spaced from the top surface 102a for a distance of 1/T; and the high nitrogen-containing portion 103b can be the region of the cover layer 103 from the ⅙T locations to the top surface 103c of the cover layer 103 (the locations spaced from the top surface 102a for a distance of T). However, it should be appreciated that the aforementioned embodiments are just illustrative, the same results may be obtained by applying different processing parameters. In some embodiments of the present disclosure, the nonmetal element may be the oxygen element (O); and similarly, the concentration of the oxygen element (O) dispersed in the cover layer 103 can be manipulated by tuning the oxygen concentration within oxygen-containing atmosphere.

In some embodiments of the present disclosure, the high nitrogen-containing portion 103b of the cover layer 103 may have a thickness ⅚T greater than a thickness ⅙T of the low nitrogen-containing portion 103a, wherein the thickness of the low nitrogen-containing portion 103a may range from 50 Å to 350 Å; and the thickness of the high nitrogen-containing portion 103b may range from 250 Å to 650 Å. In another embodiment of the present disclosure, the high nitrogen-containing portion 103b of the cover layer 103 may have a thickness less than that of the low nitrogen-containing portion 103a.

Subsequently, an optical matching layer 104 is disposed on the top surface 103c of the cover layer 103, meanwhile the process for forming the touch panel 100 as depicted in FIG. 1D can be accomplished. In some embodiments of the present disclosure, the optical matching layer 104 can be a metal oxide layer. The optical matching layer 104 has a refractive index different from that of the cover layer 103. For example, optical matching layer 104 has a refractive index substantially less than that of the cover layer 103. However, the optical properties of the optical matching layer 104 may not be limited to these regards. The optical matching layer 104 may be formed by sputtering, CVD, PVD or other suitable methods. The optical matching layer 104 may have a thickness ranging from 400 Å to 800 Å. However, it should be appreciated that the physical properties of the optical matching layer 104 may not be limited to these regards.

The optical matching layer 104 may be made of one of the materials including indium zinc oxide (IZO), indium tin oxide (ITO), indium gallium zinc oxide (IGZO), niobium oxide (Nb₂O₅), silicon nitride (SiNₓ), silicon oxide (SiOₓ), zinc oxide (ZnO), silicon aluminum oxynitride (SiAlON), aluminum and tin co-doped zinc oxide (ATZO), antimony doped tin oxide (ATO), indium oxide (In₂O₃), tin oxide (SnO₂), fluorine-doped tin oxide (FTO), copper aluminum oxide (CuAlO₂), (TiVCrZrTa)ₓO₁₋ₓ, (TiVCrZrTa)ₓN_{y}O_{1-x-y}, aluminum-doped zinc oxide (AZO), cadmium oxide (CdO), gallium-doped zinc oxide (GZO), zinc indium oxide (Zn₂In₂O₅), indium molybdenum oxide (IMO), zinc tin oxide (Zn₂SnO₄), cadmium tin oxide (Cd₂SnO₄), cadmium indium oxide (Cd₂InO₄), In₂O₃—ZnO, chromium nitride (CrN), chromium oxide (CrO), titanium nitride (TiN), fluorine-doped tin oxice (SnO₂:F), copper oxide (Cu₂O), ferrous oxide (FeO), copper gallium oxide (CuGaO₂), ternary copper oxide (SrCu₂O₂), titanium oxide (TiO₂), nickel oxide (NiO), tantalum oxide (Ta₂O₅) and the arbitrary combinations thereof. In one embodiment of the present disclosure, the optical matching layer 104 can be an IZO layer having a thickness about 600 Å.

FIG. 2 is a cross-sectional view of a touch panel 200 according to another embodiment of the present disclosure. The process for fabricating the touch panel 200 is similar to that for fabricating the touch panel 100, except that the touch panel 200 has at least one patterned sensing electrode having a metal mesh structure as it viewed from the top thereof. The forming of the patterned sensing electrode includes performing a patterning process, such as an etching process, at the structure as depicted in FIG. 1D to remove portions of the optical matching layer 104, the cover layer 103 and the conductive layer 102 to form a plurality of openings 201, wherein the process for removing portions of the optical matching layer 104, the cover layer 103 and the conductive layer 102 may be implemented either by different etching steps or by an identical etching step. In another embodiment of the present disclosure, further includes a process for forming a barrier layer on the optical matching layer 104 in a manner of thoroughly filling the openings 201. The barrier layer may be further patterned to make the remaining barrier layer partially covering the openings 201. In this embodiment, the patterned barrier layer may cover the top surface of the optical matching layer 104 and the sidewalls of the cover layer 103 and the conductive layer 102 exposed from the openings 201, so as to expose portions of the top surface 101a of the substrate 101.

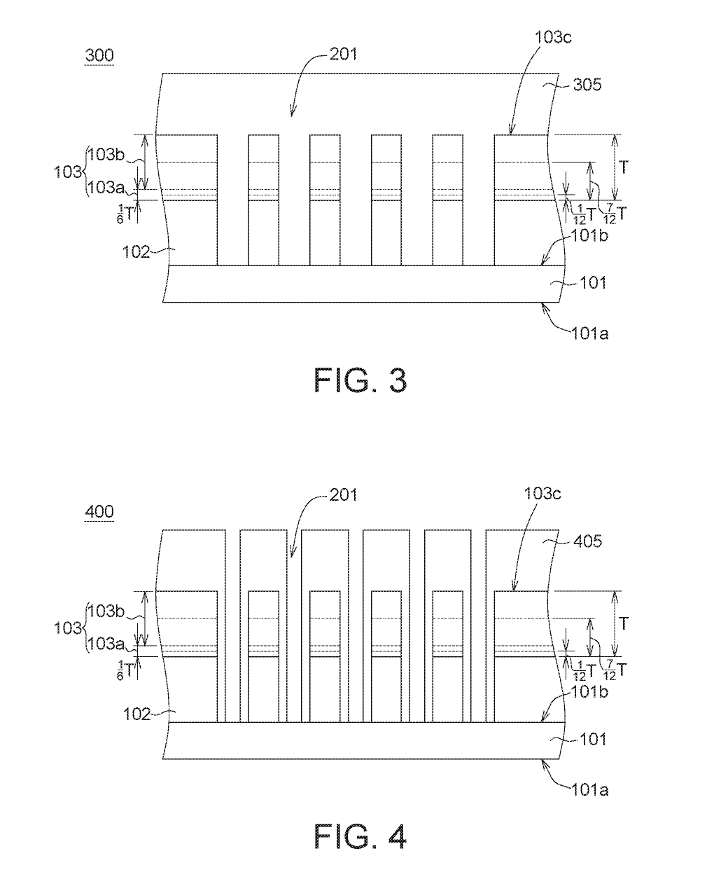

FIG. 3 is a cross-sectional view of a touch panel 300 according to yet another embodiment of the present disclosure. In the present embodiment, the optical matching layer 104 may be omitted, and a barrier layer 305 is disposed on the patterned cover layer 103 and thoroughly filling the openings 201. The patterned barrier layer may thoroughly cover the top surface 103c of the patterned cover layer 103 and the sidewalls of the cover layer 103 and the conductive layer 102 exposed from the openings 201. FIG. 4 is a cross-sectional view of a touch panel 400 according to yet another embodiment of the present disclosure. In the present embodiment, barrier layer 405 disposed on the op surface 103c of the patterned cover layer 103 may be further patterned to make the remaining barrier layer 405 partially covering the openings 201, whereby the top surface 103c of the patterned cover layer 103 and the sidewalls of the cover layer 103 and the conductive layer 102 exposed from the openings 201 can be covered by the patterned barrier layer, and the top surface 101a of the substrate 101 can be partially exposed. In these embodiments where the optical matching layer 104 is omitted, the problems of overhangs formed in the optical matching layer 104 due to the difference in the etching rate of the patterning process for partially etching the cover layer 103 and the optical matching layer 104 can be avoided by the omission of the optical matching layer 104. Such that the yield of the process for forming the touch panel 400 can be improved. Of note that the overhangs are portions of the optical matching layer 104 protruding from the sidewalls of the cover layer 103 exposed from the openings 20, that are resulted from the difference in the etching rate of the patterning process for removing the cover layer 103 and the optical matching layer 104.

The barrier layers 305 and 405 may be made of one of the materials including organic photo-resist material, SiNₓ, IGZO, Nb₂O₅, SiOₓ, ZnO, SiAlO, TZO, ATO, In₂O₃, SnO₂, FTO, CuAlO₂, (TiVCrZrTa)ₓO₁₋ₓ, (TiVCrZrTa)ₓNO_{1-x-y}, AZO, CdO, GZO, Zn₂In₂O₅, IMO, Zn₂SnO₄, Cd₂SnO₄, Cd₂InO₄, In₂O₃—ZnO, CrN, CrO, TiN, SnO₂:F, Cu₂O, FeO, CuGaO₂, SrCu₂O₂, TiO₂, NiO, Ta₂O₅ and other transparent material that can resist the corrosion of salt water.

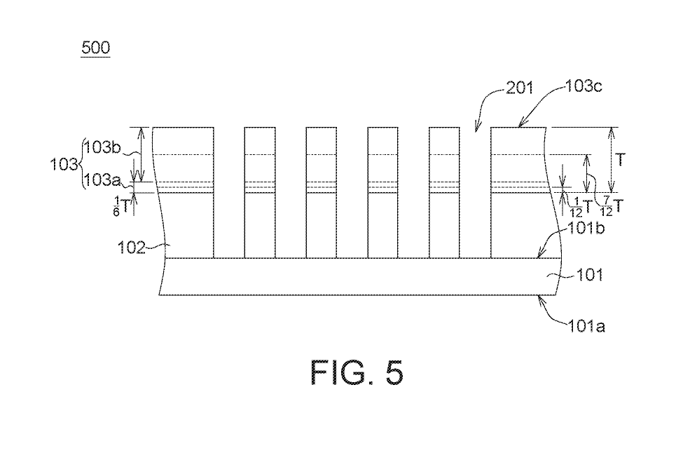

FIG. 5 is a cross-sectional view of a touch panel 500 according to yet another embodiment of the present disclosure. In the present embodiment, the optical matching layer 104 and the barrier layer 405 as depicted in FIG. 4 are omitted to form the touch panel 500. The forming of the patterned sensing electrode includes performing a patterning process, such as an etching process, at the structure as depicted in FIG. 1C to remove portions of the cover layer 103 and the conductive layer 102 to form a plurality of openings 201. In the present embodiment, the touch panel 500 does not include the optical matching layer 104, the problems of overhangs formed in the optical matching layer 104 due to the difference in the etching rate of the patterning process for partially removing the cover layer 103 and the optical matching layer 104 can be avoided by the omission of the optical matching layer 104. Such that the yield of the process for forming the touch panel 500 can be improved.

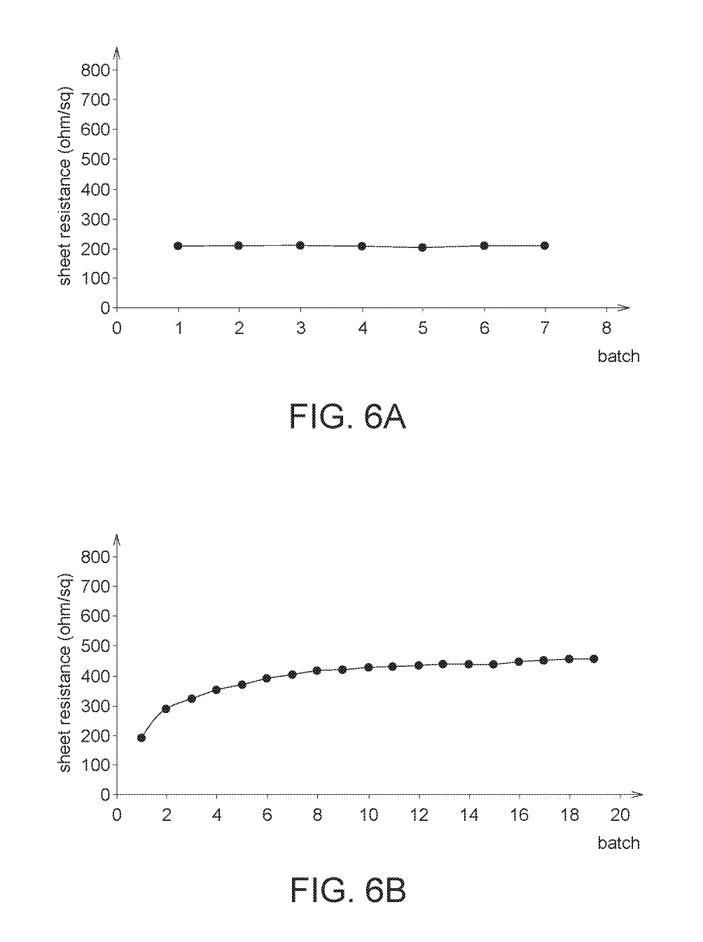

The results in comparison the sheet resistance of touch panels 300 having a not patterned sensing electrode and provided by the aforementioned embodiments with that of a touch panels provided by a comparative embodiment are described in FIGS. 6A and 6B. FIG. 6A is a curve diagram illustrating the variation in sheet resistance of the touch panel 300 of the present disclosure between different manufacturing batches; and FIG. 6B is a curve diagram illustrating the variation in sheet resistance of touch panels provided by the comparative embodiment between different manufacturing batches. The difference between the process for fabricating the touch panel 300 of the embodiment of FIG. 3 and the process for fabricating the touch panel of the comparison embodiment is the steps for forming the cover layer 103. In the embodiment of FIG. 3, the cover layer 103 may be formed in an atmosphere using a reactive gas with lower nitrogen concentration at the beginning, and the nitrogen concentration of the reactive gas is then increased latter. In the comparative embodiment, the nitrogen concentration of the reactive gas is kept steadily. Each point depicted along the horizontal axis of FIGS. 6A and 6B represents a process batch; and a plurality of adjacent points represent the sheet resistance of the touch panel provide by several continuous process batches which can be integrated to form the curve diagram. The vertical axis of the diagram represents sheet resistance (ohm/sq) measured from the touch panel.

According to the result of FIGS. 6A and 6B, it can be observed that the sheet resistance of the metal nitride layer used to compose the sensing electrode of the touch panel provided by the comparative embodiment is gradually increased after performing a plurality of continuous process (see FIG. 6B). The sheet resistance is steeply increased from 200 ohm/sq to 400 ohm/sq even to the level greater than 450 ohm/sq. In contrast, the sheet resistance of the sensing electrode of the touch panel 300 provided by the embodiment of FIG. 3 is kept steadily at the level about 200 ohm/sq (see FIG. 6A) after performing a plurality of continuous process. It can be determined that target poisoning does not occur on the sensing electrode of the touch panel provided by the embodiment of FIG. 3 after performing a plurality of continuous process, thus the sheet resistance of the sensing electrode is not increased.

The touch panel 300 provided by the embodiment of FIG. 3 and the touch panel provided by the comparative embodiment are both subjected to a salt spry test to analysis the reliability under a harsh environment. The touch panel 300 provided by the embodiment of FIG. 3 is immersed in a 5 wt % sodium chloride solution for 24 hours. After the touch panel 300 is taken out of the sodium chloride solution, no corrosion occurring on the conductive layer 102 beneath the cover layer 103 is observed. The observation of the conductive layer 102 is performed to measure the macroscopic reality by the naked eye instead of observing the microscopic one. However, it cannot be precluded that a corrosion occurring on the conductive layer 102 may be observed when the observation is performed by microscopic view point. In contrast, severe corrosion can be observed occurring on the conductive layer 102 of the touch panel provided by the comparative embodiment after immersed in the 5 wt % sodium chloride solution for 24 hours. These results indicate that the touch panel 300 provided by the embodiment of FIG. 3 has better corrosion resistance and reliability, in comparison with the touch panel provided by the comparison embodiment.

After serious downstream processes, such as metal layer patterning, wiring, assembling, bounding and the like, are carried out, a touch control module 71 is formed; and the touch control module 71 is then assembled with a display unit 72 to form a touch display device 70 with a touch control function. In one embodiment of the present disclosure, the display unit 72 includes a backlight module 73 and a display panel 74, and the substrate 101 of the display panel 74 can also serve as the substrate for forming the touch control module 71. The display unit 72 includes a self-illuminating display panel 74, such as a quantum dots (QD) panel, a light-emitting diode (LED) display panel or an organic light-emitting diode (OLED) display panel. In the present embodiment of FIG. 7, the barrier layer or the package layer for covering the light emitting layer of the display panel 74 can serve as the substrate 101 for forming the touch control module 71, wherein the touch control module 71 can be a capacitive touch module, and the electrode layer composed by the conductive layer 102, the cover layer 103 and the optical matching layer 104 can be patterned to form the sensing electrodes of the capacitive touch module (see FIG. 7). FIG. 7 is a cross-sectional view illustrating the touch display device 70 applying the touch panel 300 depicted in FIG. 3. In the present embodiment, the touch display device 70 includes a touch control module 71, a display panel 74 and a protection board 76. The backlight module 73 is disposed adjacent to the display panel 74, and the protection board 76 is disposed on the side of the display panel 74 opposite to the backlight module 73.

In detailed, the display panel 74 includes the substrate 101, a color filter 711, a display medium layer 712 (e.g. the liquid crystal layer), a thin-film transistor (TFT) circuit board 713, a bottom polarizer 714 and a top polarizer 715. The backlight module 73 is disposed adjacent to the bottom polarizer 714 of the display panel 74, the touch panel 300 is disposed between the color filter 711 and the top polarizer 715. In another embodiment of the present disclosure, the display panel 74 may further include a quantum dot enhancement film (QDEF), and the color filter 711 can be substituted by a colored photoresist layer or a transparent photoresist layer doped with quantum dots.

In according to the aforementioned embodiments, a touch panel and a touch display device applying the same are disclosed. A cover layer having the nonmetal element disperse therein with various concentrations is formed on a conductive layer used to make the sensing electrodes of the touch panel. The cover layer having the nonmetal element disperse therein with various concentrations may not trigger target poisoning during the continuous sputtering process for forming the same. In addition, the cover layer can prevent the sensing electrode of the touch panel from being damaged by external pollutants, such as salt spray, without deteriorate the display quality of the touch display device. Such that the reliability of the touch display device can be improved.

It should be appreciated that the features respectively described in different embodiments of the present disclosure can be combined with each other, under the premise in the absence of mutual exclusion, to form another embodiment without deviating the scope of the present invention.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch panel comprising:
a substrate;
a conductive layer, disposed on the substrate; and
a cover layer, disposed on the conductive layer and comprising a nonmetal element, wherein the cover layer has a thickness of T; the nonmetal element at a first location of the cover layer where spaced from the conductive layer for a distance of 1/12T has a first concentration; the nonmetal element at a second location of the cover layer where spaced from the conductive layer for a distance of 7/12T has a second concentration; and the first concentration is less than the second concentration.

2. The touch panel according to claim 1, wherein the nonmetal element dispersed in a region of the cover layer from a top surface of the conductive layer to a third location spaced from the top surface for a distance of ⅙T has a first average concentration; the nonmetal element dispersed in a region of the cover layer from the third location to a fourth location spaced from the top surface for a distance of T has a second average concentration; and the first average concentration is less than the second average concentration.

3. The touch panel according to claim 1, wherein the nonmetal element dispersed in the cover layer has a concentration gradient with a concentration gradually increased along a direction away from the conductive layer.

4. The touch panel according to claim 1, wherein the cover layer is a metal oxide layer and the nonmetal element is an oxygen element (O).

5. The touch panel according to claim 1, wherein the cover layer is a metal nitride layer and the nonmetal element is a nitrogen element (N).

6. The touch panel according to claim 1, wherein the first concentration is greater than or equal to 2 at % and less than or equal to 30 at %; and the second concentration is greater than or equal to 30 at % and less than or equal to 80 at %.

7. The touch panel according to claim 1, further comprising an optical matching layer disposed on the cover layer.

8. The touch panel according to claim 7, wherein the optical matching layer is an indium zinc oxide (IZO) layer.

9. The touch panel according to claim 1, further comprising a barrier layer disposed on the cover layer.

10. The touch panel according to claim 1, further comprising a patterned barrier layer disposed on the cover layer and exposing a portion of the substrate.

11. A touch display device, comprising:
a display unit
a substrate, disposed on the display unit;
a conductive layer, disposed on the substrate; and
a cover layer, disposed on the conductive layer and comprising a nonmetal element, wherein the cover layer has a thickness of T; the nonmetal element at a first location of the cover layer where spaced from the conductive layer for a distance 1/12T has a first concentration; the nonmetal element at a second location of the cover layer where spaced from the conductive layer for a distance of 7/12T has a second concentration; and the first concentration is less than the second concentration.

12. The touch display device according to claim 11, wherein the nonmetal element dispersed in a region of the cover layer from a top surface of the conductive layer to a third location spaced from the top surface for a distance of ⅙T has a first average concentration; the nonmetal element dispersed in a region of the cover layer from the third location to a fourth location spaced from the top surface for a distance of T has a second average concentration; and the first average concentration is less than the second average concentration.

13. The touch display device according to claim 11, wherein the nonmetal element dispersed in the cover layer has a concentration gradient with a concentration gradually increased along a direction away from the conductive layer.

14. The touch display device according to claim 11, wherein the cover layer is a metal oxide layer and the nonmetal element is an oxygen element (O).

15. The touch display device according to claim 11, wherein the cover layer is a metal nitride layer and the nonmetal element is a nitrogen element (N).

16. The touch display device according to claim 11, wherein the first concentration is greater than or equal to 2 at % and less than or equal to 30 at %; and the second concentration is greater than or equal to 30 at % and less than or equal to 80 at %.

17. The touch display device according to claim 11, further comprising an optical matching layer disposed on the cover layer.

18. The touch display device according to claim 17, wherein the optical matching layer is an indium zinc oxide (IZO) layer.

19. The touch display device according to claim 11, further comprising a barrier layer disposed on the cover layer.

20. The touch display device according to claim 11, further comprising a patterned barrier layer disposed on the cover layer and exposing a portion of the substrate.
